(19) United States
(12) Patent Application Publication
(10) Pub. No.: US 2026/0141283 A1
(43) Pub. Date: May 21, 2026

(54) METHOD FOR GENERATING SYNTHETIC SPECTRAL DATA

(71) Applicant: COMMISSARIAT A L’ENERGIE ATOMIQUE ET AUX ENERGIES ALTERNATIVES, PARIS (FR)

(72) Inventors: Riccardo FINOTELLO, BURES SUR YVETTE (FR); Mohamed TAMAAZOUSTI, CLAMART (FR); Jean-Baptiste SIRVEN, PARIS (FR)

(21) Appl. No.: 18/877,226

(22) PCT Filed: May 24, 2023
(86) PCT No.: PCT/EP2023/063877

§ 371 Date: Dec. 19, 2024

(30) Foreign Application Priority Data
Jun. 21, 2022 (FR) 2206069

(51) Int. Cl. G06N 20/00; G01N 21/71

(52) U.S. Cl. CPC G06N 20/00; G01N 21/718

(57) ABSTRACT

A computer-implemented method for synthesizing spectral data includes the following steps: acquiring a set of spectral data each associating a spectrum with a sample having a given chemical composition, using a spectroscopy method, determining a theoretical model of the distribution of the intensities of the spectrum for each wavelength channel of the spectrum, generating a set of synthetic spectral data by generating, for each wavelength channel of the spectrum, a randomly drawn intensity according to the probability distribution of the theoretical model.

### CROSS-REFERENCE TO RELATED APPLICATIONS

This application is a National Stage of International patent application PCT/EP2023/063877, filed on May 24, 2023, which claims priority to foreign French patent application No. FR 2206069, filed on Jun. 21, 2022, the disclosures of which are incorporated by reference in their entireties.

### FIELD OF THE INVENTION

The invention relates to the field of the analysis of spectral data, that is to say of data having a plurality of intensity values in various wavelength channels or spectral bands. The data may be both multispectral or hyperspectral data, in which the number of spectral bands varies from a few tens into the hundreds, and data originating from emission or absorption spectra of a chemical species, containing thousands of wavelength channels. The invention is applicable to any type of spectral analysis provided that a large number of replicas of the input data is necessary, and that these are not readily available in large quantities. The invention is applicable in particular, but not exclusively, for quantitative analysis (for example determining concentration) or for classification of samples for which spectral data are measured.

More specifically, the invention relates to a method for synthesizing synthetic spectral data so as to provide learning data for a machine learning engine for analysis of species associated with the spectral data, notably, but not exclusively, for quantitative or qualitative analysis of chemical species.

### BACKGROUND

One possible application of the invention relates to determining the concentration of chemical elements or classifying samples based on spectral data that are acquired for example by way of a laser-induced breakdown spectroscopy (LIBS) technique. The invention is not limited to this particular technique, and may be applied to any type of spectroscopy technique that produces multispectral or hyperspectral data or spectral data on emission or absorption of chemical species.

The invention is applicable to any type of spectral analysis. In fact, the invention may be used in the context of quantitative analysis, which consists for example in predicting a quantity characterizing samples to be analyzed. It is also applicable to qualitative analysis, such as segmentation or identification of scenes or maps using a technique that produces multispectral or hyperspectral images or spectra of chemical species obtained using a spectroscopic technique such as LIBS or the like. In addition, it may also be applied to generating samples for super-resolution and other unsupervised learning techniques. The difference is simply the nature of the variables to be predicted or to be processed, which are for example continuous in terms of quantification (for example, the concentration of a species), discrete in terms of classification (for example, a class or category label), or of the same type as the input data for unsupervised analysis (for example, the intensity values of the spectral bands of a pixel in image super-resolution).

In the context of spectral data, various processing methods are used for various types of analyses. In particular, multivariate deep learning methods, based mainly on artificial neural networks, have been explored and used, for example for quantitative analysis (calibration, regression) or for classification of samples. Examples of such methods are described in references [1]-[3]. However, these algorithms are generally characterized by their ability to learn based on a very high number of implementations (spectra), thereby limiting use thereof in the case where the available datasets contain a limited number of implementations.

Unlike the most widely used approaches based on fully connected neural networks as presented in [4], recent developments in spectral signature analysis have led to the introduction of architectures inspired by object detection and image classification algorithms based on convolutional neural networks (see for example [5] and [6]). Although the same problem arises for all neural network models, this type of architecture in particular aims to learn models based on training data, this requiring a large number of implementations in order to correctly learn to associate, based on a model, for example in the context of supervised learning, input data with output data. By way of example, standard datasets for image processing contain a number of training data of the order of 10⁴ to 10⁶ samples (see [20]), whereas conventional LIBS datasets contain tens or hundreds of spectra (see [7]), or a few thousand to tens of thousands for LIBS mapping (see [8]). This observation is also true for other types of spectroscopy.

Obtaining a large number of spectral data is a problem to be solved. For example, in the context of LIBS spectroscopy, the collection of a large number of spectra may be prevented by destruction of the surface of the sample, or by an available surface area that is too small, or even by a simple matter of time (for example the inability to probe a given area quickly enough).

Beyond LIBS spectroscopy, the lack of training spectral data may also be attributed to the high cost of obtaining a sufficient number of labeled data for learning.

There is therefore a need to realistically augment the number of learning data available for spectral data.

The problem of a lack of implementations in the context of spectral analysis is seldom addressed in the literature. There are a few works, commented upon below, that aim to enrich the information given to architectures (for example neural networks) or to focus only on an arbitrarily relevant portion of the information, but, from the point of view of deep learning techniques, the absence of a large number of different implementations (that is to say spectra) may still lead to problems with overfitting or poor generalization performance.

In general, data augmentation and synthesis are methods used in the context of deep learning, for example in the context of computer vision. The basic idea is to create oversampling of the input data in a non-trivial manner. Conventionally, with data augmentation, learning data are enriched using transformations (rotations, enlargements, reflections, etc.) of the training data so as to produce new implementations (see for example [9], [10], [12] and [18]) in most deep learning applications, such as image classification, time series, natural language processing, etc. This procedure makes it possible to produce an arbitrary number (except constraints related to the size or form of the data) of examples that are produced directly based on the distribution of the training data. The effect is that of regularizing and stabilizing learning, thereby generating a model that generalizes better, either in the context of classification or for regression tasks. Synthesis of new data is commonly used for image processing (for example super-resolution) [11]. In addition, the development of deep learning models on smaller datasets, in particular spectroscopic datasets or in the context of one-shot learning in computer vision, is a highly topical issue.

For example, reference [2] relates to a “data augmentation” method for the LIBS technique using time-resolved spectra of chemical elements for multivariate analysis with shallow neural networks. In other words, for each crater on the surface, instead of a single spectral signature, multiple spectra are recorded at different times of the laser shot. The concatenation of these spectra is then used, for each crater, as being representative of the measurement, which now has an additional temporal direction, hence the name “time-resolved spectra”. The dataset used for the analysis of neural networks thus consists of a collection of time-resolved spectra. Here, the term data “augmentation” is not used correctly. Indeed, the number of implementations is not actually augmented, but the quantity of information for a given implementation is augmented. It could be said that the quality of the data has certainly been augmented, even though no new datum has been produced. The analysis proposed in reference [3] uses the same type of time-resolved data, without explicitly mentioning “data augmentation”.

The methods described in references [13] and [14] use deep learning methods, for the analysis of LIBS data, based on convolutional neural networks. However, the problem of data augmentation is not addressed therein. More recently, the authors in introduced a data augmentation technique derived directly from standard deep learning image processing methodology. Their analysis is, once again, based on convolutional neural networks and focuses on elementary two-dimensional maps with a spatial resolution of 150 μm between craters. Proceeding from maps obtained based on the intensity of preselected lines, they use slices, recombinations, image filters (for example, addition of Gaussian noise and a median filter) and reflections to produce additional learning data to classify samples. It should be noted that, in this case, the authors do not directly use the spectral information contained in the original data, but they extract maps so as to exploit the spatial information therein. The augmentation is then carried out directly on the maps. In the context of image classification, and for the purposes illustrated by the authors, the techniques used in the article may improve the generalization capabilities of the classifier network. However, for more general purposes, using slices and recombinations to generate new images does not directly modify the data associated with each pixel (that is to say with each crater), but reorganizes them via the map: such a data augmentation technique leads to oversampling of the data collected in the intensity map, rather than to the production of spectra. For example, other types of analyses, such as multivariate regression for quantitative analysis, might not benefit greatly from this processing, since it may be considered to be a simple replication of the input data of the regression network (although it may lead to slight performance improvements). Moreover, very small elementary maps, in which only a small number of laser shots are carried out, might benefit only marginally from this, since the number of relevant transformations is considerably reduced.

Review article presents the concept of data augmentation by proposing to generate an arbitrary number of spectra by adding random noise to each experimental spectrum. However, no implementation of this technique is shown in the article, and no definition of the random noise is proposed.

Other analyses described in reference [17] use various types of LIBS spectroscopy data, for example considering only specific wavelength channels for analysis, in order to reduce the size of the training data relative to the size of the neural network model. This approach makes it possible to use a reduced version of the input data, where the information assumed to be relevant has been extracted beforehand to improve the analysis. However, this may still lead to problems with overfitting and poor generalization capability due to the limited number of data available, but also to a possible reduction in performance due to the loss of information due to the prior selection of the input data.

In the context of the analysis of multispectral or hyperspectral images, mention may also be made of traditional data augmentation methods, which are generally defined for tasks such as object detection or semantic segmentation (for example, reference [9] gives examples and a complete bibliography of the prior art). However, in this context, the purpose of the analysis is different and generally limited to classifying or characterizing scenes (similarly, these techniques have also been applied in the context of LIBS spectroscopy in [15], as discussed above).

### SUMMARY OF THE INVENTION

The invention aims to overcome the limitations of the prior art by providing a method for synthesizing spectral data that makes it possible to better exploit deep learning algorithms and, more generally, any algorithm that requires a large number of input spectral data. This provision makes it possible to implement more efficient algorithms that are capable of reducing prediction uncertainties and of building reliable models, but that require a large number of learning data.

The invention proposes a method for synthesizing spectral data, able to be used for learning as regularization and oversampling of training data, or directly as learning data. The synthesis method according to the invention is based on experimental data to model the distribution of the signal.

This distribution may then be used to generate an arbitrary number of spectra, which statistically represent the real data. This new dataset may be used to train deep learning algorithms, which require a large number of data: since these data model a real distribution, the algorithms maintain their predictive capability and their accuracy on new data acquired experimentally using a spectroscopy method.

The invention, in contrast to some techniques from the prior art, focuses on the generation of an arbitrary number of truly different training spectral data, statistically representing the experimental dataset, without a constraint on the number of wavelength channels or spectral bands contained in the spectra.

The invention proposes a technique different from the prior art to synthesize an arbitrary number of spectra. Since the direct addition of random noise to a limited number of spectra may modify the learning distribution (that is to say it may change the nature of the distribution, given that the number of implementations is relatively small), the spectra are first modeled on the basis of a known or estimated statistical distribution (for example using a kernel density estimation method), and then generated according to their statistical distribution so as to expand the feature space of the input data, that is to say covering a larger part of the domain of definition of the distribution. In this way, the generated dataset is always a statistical representation of the original data with an arbitrarily large number of replicas. Random noise (which is for example Gaussian or uniform in nature) may then be added separately to each synthesized replica in order to improve the generalization capability of the algorithm. The use of synthesized data provides a sufficiently large number of input data so that the addition of noise is negligible on average, without any overall impact on the distribution of the data. On the contrary, adding noise to a limited number of data may significantly change the nature of the data and disturb the learning of the algorithms. Generation based on a statistical distribution guarantees that each replica is a different representation of the training data, thereby giving the algorithm the ability to learn a larger quantity of features, and that the number of replicas is large enough to guarantee that, statistically, the learning distribution is representative of the samples under analysis.

Unlike the prior art, the invention proposes an augmentation method linked directly to the nature of the spectral signatures in order to solve the problem of the number of spectra available for learning. Since no prior knowledge about the type of spectral data is necessary (for example, it may be estimated), the same principle presented here may be extended to any type of multispectral or hyperspectral data, not necessarily linked to the LIBS technique.

The invention relates to a method for modeling the distribution of spectra for realistic data synthesis, compared to experimental data. The invention also provides a step of adding random noise from the synthesized data, unlike the addition of noise directly to the original data. This technique makes it possible to generate an arbitrary number of data effectively representative of the samples and, then, to modify the spectral intensities, without altering on average the original distribution of the experimental data (which, in applications, consists of only a few implementations, and is not representative of the true distribution of the data).

Unlike the usual data augmentation techniques in computer vision, any transformation (shift, translation, reflection, expansion) applied to the spectral data will certainly change the physical significance of the spectra: for example, the wavelength translation of an emission line assigned to one element may lead to it being assigned to another element. The invention proposes to generate new learning spectra, that is to say to synthesize learning data using a theoretical model of the distribution of real data. In other words, the spectral profile obtained experimentally using a spectroscopy method is used to generate spectra having, on average, the same distribution for each wavelength channel. This approach makes it possible to solve the problem of the number of implementations (spectral signatures), without distorting the physical content of the spectra. The spectra are generated using random extractions based on this distribution: the method also makes it possible to cover a larger part of the space in which the original data are defined (for example, in the context of spectroscopic data, the wavelength space).

One subject of the invention is a computer-implemented method for synthesizing spectral data, comprising the following steps:
Acquiring a set of spectral data each associating a spectrum with a sample having a given chemical composition, using a spectroscopy method,
Determining a theoretical model of the distribution of the intensities of the spectrum for each wavelength channel of the spectrum,
Generating a set of synthetic spectral data by generating, for each wavelength channel of the spectrum, a randomly drawn intensity according to the probability distribution of the theoretical model.

According to one particular aspect of the invention, the theoretical model is based on a probability distribution in accordance with a Poisson distribution parametrized by the intensity measured on the acquired spectrum.

According to one particular aspect of the invention, the set of spectral data comprises multiple measurements of spectra for the same sample and the method comprises a step of determining the average spectrum over the set of measurements.

According to one particular aspect of the invention, the synthetic spectral data are generated by adding, to the randomly drawn intensity, a noise value drawn according to a uniform distribution within an interval centered on the intensity and of parametrizable width.

According to one particular aspect of the invention, the synthetic spectral data are generated by adding, to the randomly drawn intensity, a noise value drawn according to a normal distribution centered on the intensity, the standard deviation of which is a modifiable parameter.

According to one particular aspect of the invention, the spectral data are acquired by way of a laser-induced breakdown spectroscopy method.

According to one particular aspect of the invention, the spectral data originate from emission or absorption spectra of chemical species.

Another subject of the invention is a method for the quantitative or qualitative analysis of spectral data, comprising the following steps:
Generating a set of synthetic spectral data by carrying out the method for synthesizing spectral data according to the invention,
Training a machine learning model based on the generated synthetic spectral data,
Using the trained model to carry out quantitative or qualitative analysis of spectral data.

Another subject of the invention is a computer program comprising instructions for carrying out a method according to the invention when the program is executed by a processor, and also a processor-readable recording medium on which there is recorded a program comprising instructions for carrying out a method according to the invention when the program is executed by a processor.

### BRIEF DESCRIPTION OF THE DRAWINGS

Other features and advantages of the present invention will become more apparent on reading the following description in relation to the following appended drawings.

FIG. 1 shows one example of spectral data characterizing a sample containing various chemical species,

FIG. 2 shows a diagram of the steps for implementing a method for generating synthetic spectral data according to the invention,

FIG. 3 shows a flowchart of the steps for implementing a method for the machine learning of a spectral data analysis model according to the invention,

FIG. 4 shows a quantile-quantile plot of the real and synthetic distributions for a cement sample (type I) with the addition of NaCl,

FIG. 5a shows one example of an average spectrum, FIG. 5b shows an illustration of the results obtained by the invention with Gaussian modeling, FIG. 5c shows an illustration of the results obtained by the invention with modeling based on a “top-hat” kernel, FIG. 5 shows a comparative illustration of the results obtained by the invention with Gaussian modeling and modeling based on a “top-hat” kernel.

### DETAILED DESCRIPTION

LIBS technology makes it possible to carry out material analysis through laser ablation and spectroscopy. The data acquired via this technique are spectral data that correspond, for each point of an area, to an emission spectrum comprising atomic lines that are characteristic of the elementary chemical composition of the sample.

LIBS spectral data are obtained by focusing a laser beam on a point of a surface to be analyzed. The emission of a plasma resulting from this focus is collected and processed through spectroscopy to obtain a spectrum of atomic lines. The process is iterated for each point of the area to be analyzed.

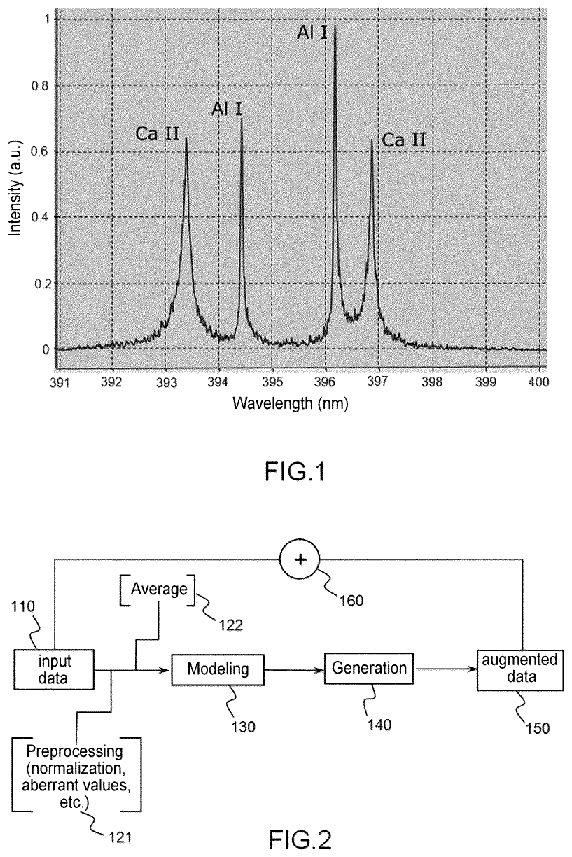

FIG. 1 shows, by way of illustration, one example of a spectrum of atomic lines 101 obtained for a sample having a certain chemical composition. In FIG. 1, the spectral signatures of certain chemical elements (Ca, Al) corresponding to atomic lines in given wavelength channels have been identified.

As explained in the preamble, the invention aims to generate synthetic spectral data based on one or more measurements of spectral data of the type described in FIG. 1.

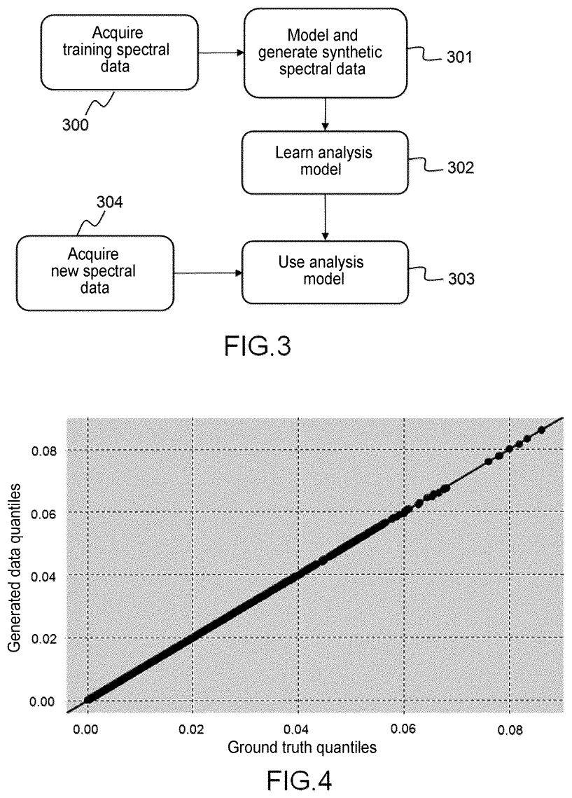

The method according to the invention is described in FIG. 2.

The first step 110 consists in acquiring spectral data by way of an appropriate acquisition device depending on the intended application. If the application concerns qualitative or quantitative analysis of samples, for example of a material, the data are spectral data and are for example acquired by way of a spectrometry device, for example a laser-induced breakdown spectroscopy device, or a device based on a mass spectrometry technique coupled with laser ablation or with an ion beam or with an X-ray beam or else a synchrotron radiation-induced or charged particle beam-induced spectrometry technique or else Raman or IR spectrometry. If the application relates to a method for mapping a geographical area, the multispectral or hyperspectral data are for example acquired by way of a multispectral or hyperspectral imaging sensor on board a satellite payload. The invention applies more generally to any other multispectral or hyperspectral data acquisition device that makes it possible to generate, for a given sample, a spectrum in a given wavelength range.

The first step 110 may consist in measuring a single spectrum per sample or multiple spectra per sample.

In an optional step 121, the measured spectral data are preprocessed in order to estimate and correct any offset linked to acquisition, to normalize the various measured spectra so that they are homogeneous with one another and to eliminate blind spots if they exist. In other words, each measured spectrum may be normalized in various ways, for example using a known emission/absorption line or wavelength band, either using the maximum intensity or using other methods. If using multiple spectra that are assumed to be representative of the measurement, it is also possible to focus on a specific wavelength channel, consider the average intensity and discard spectra that contain aberrant values for this channel from the set of data. This preprocessing makes it possible to use only the spectra that are most representative of the sample, without necessarily modeling defects at the same time.

If multiple measurements of spectra are carried out for the same sample, the spectra are averaged in step 122. In other words, it is possible to use multiple spectra representing the same sample to model the distribution (for example, following multiple laser shots on the same sample in the context of the LIBS technique). The spectra used to generate the synthetic data are averaged so as to obtain a more accurate representation of the sample under analysis. In other words, instead of using a single spectrum as being representative of a sample, it is possible to replicate the spectroscopic measurement several times and use the average spectrum obtained from a sample for synthesis. This approach makes it possible to have a more accurate representation of the sample, taking into account possible differences on average over the surface. However, it should be noted that this implementation of the invention is more specifically applicable to spectral data without the notion of an image, that is to say for data for which the spectroscopic measurement may be repeated without changes in the physical significance of the data (each spectrum must be representative of the same distribution). The application of this implementation to multispectral or hyperspectral maps implies the presence of multiple implementations of the same image in order to be able to average the contribution of a single pixel. This application is not possible with the LIBS technique since the destructive nature of the interaction of the laser with the surface does not allow the measurement to be reproduced at the same location. On the other hand, acquiring multispectral or hyperspectral images using an orbital mapping method, for example, makes it possible to replicate the same image multiple times.

In any case, an experimental measurement of a spectrum is obtained.

Next, a model of the distribution of the intensity values of the spectral lines is determined (step 130) based on the experimental measurement.

In the case of spectral data obtained using a LIBS acquisition method, the main source of noise at low intensities and of the signal at high intensities is the photons that have impacted the detector. It is therefore possible to estimate the actual distribution of the spectral data using a distribution that models the photon count.

The distribution model that is used is therefore based on a Poisson probability distribution expressed by the formula

$${P}_{ℓ} ( X = k ) = \frac{{ℓ}^{k} {e}^{- ℓ}}{k !} ,$$

where k is the variable of the distribution, which here is the intensity of the lines of the spectrum, and [symbol] is the parameter of the Poisson distribution.

If [symbol] ₙ denotes the parameter of the Poisson distribution for the wavelength channel n, this parameter also corresponds to the expected average of the distribution for the channel n. Consequently, in the context of the invention, for each wavelength channel n, [symbol] ₙ=Iₙ is imposed, that is to say the peak of the probability distribution of the synthetic spectra in a channel n is equal to the intensity Iₙ recorded for the channel in the experimental spectrum that is considered to model the synthetic spectra (the one supplied at the input of step 130, possibly averaged in step 122).

Next, in step 140, new synthetic spectral data are generated based on the model obtained in step 130 for each wavelength channel n. A new synthetic spectrum is obtained by determining each intensity of the spectrum for each wavelength n by way of a random draw according to the intensity distribution model obtained in step 130. The random extraction is calculated by reversing the cumulative distribution function and by using it to represent a random variable, distributed uniformly within the interval [0, 1], in the probability space. It is thus possible to generate an arbitrary number of spectra statistically having the same properties as the experimental spectra 110.

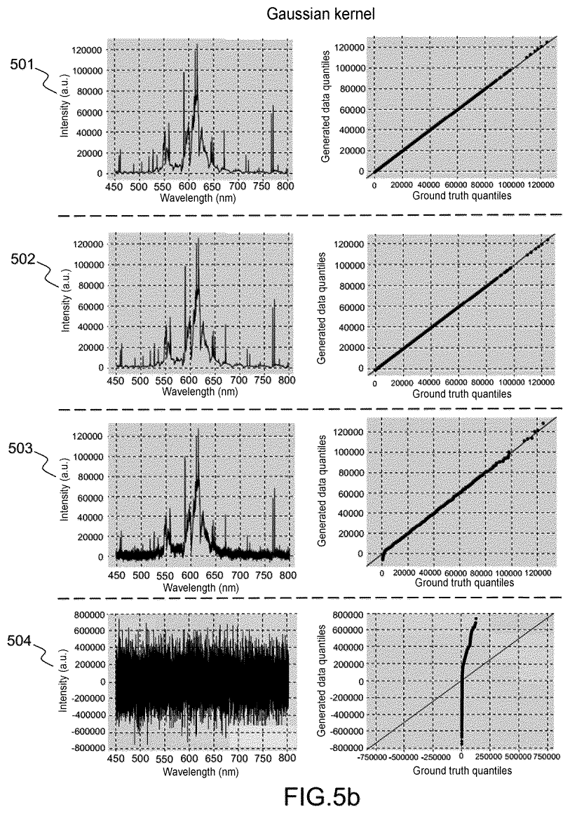

By way of illustrative example, FIG. 4 shows the quantile-quantile plot of the real and synthetic distributions for a cement sample (type I) with the addition of NaCl. The data were synthesized by modeling the intensity using a Poisson distribution. The plot shows points aligned on the bisector of the first quadrant: the observed quantiles effectively overlap the quantiles of the experimental distribution.

A set of synthetic spectral data 150 is then obtained, these data being greater in number than it would be possible to achieve experimentally. The set of synthetic data 150 may then be used as a learning set comprising spectra that represent, at the same time, the same distribution of the input data and different implementations of the experimental measurements (that is to say new data, independent of the experimental data).

In one variant embodiment of the invention, instead of modeling the intensity of each wavelength channel using a Poisson distribution, it is possible to model the distribution of the intensities of the spectrum using for example a non-parametric kernel density estimation (KDE) method, as described for example in the reference M. Rosenblatt. “Remarks on Some Nonparametric Estimates of a Density Function.” Ann. Math. Statist. 27 (3) 832-837, September 1956. In this variant, a kernel function K(z,h) is used to estimate the density ƒ(x) of a random variable x (intensity, in the case of spectra), using a certain number of implementations (experimental spectra) {\hat{x}ᵢ}_{i=1, . . . , N}. The form of ƒ(x) is estimated using a function

$$\hat{{f}_{a}} ( x ) = \frac{1}{N} {Σ}_{i = 1}^{N} K ( x - {x}_{i} , h )$$

for each value of x. The parameter a represents a bandwidth, which may be adapted to improve the estimation of ƒ(x) by \hat{ƒ}ₐ(x).

The function ƒ(x) may be estimated through various choices of the kernel K. In some variants that may be used for spectral analysis, it is possible to choose K(x,h)∝e^{-x}^{²}^{/(2a}^{²}⁾ (“Gaussian” kernel) or, for example, K(x,h)∝θ(h−x) (known as “top-hat” kernel), where θ is the Heaviside function. The choice of a normally depends on the type of data to be modeled: a smaller bandwidth makes it possible to better adapt the profile of the kernel to the data, at the risk of generating oversampling effects. To choose a, it is possible for example to use quantile-quantile plots to compare the distribution of the real data and the distribution of the synthesized data using the spectral intensity density estimator \hat{ƒ}ₐ(x).

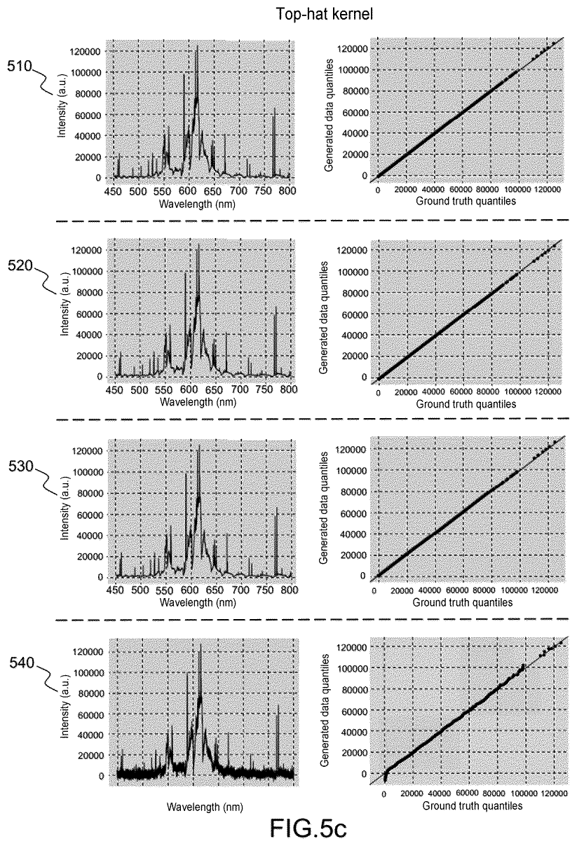

FIGS. 5a, 5b and 5c show the comparison of the modeling, using a Gaussian kernel and a “top-hat” kernel, of a cement sample (type I) with the addition of NaCl analyzed using a LIBS technique. The average spectrum 500 is indicated in FIG. 5a. Various spectra 501, 502, 503, 504 obtained for a Gaussian kernel are indicated in FIG. 5b. Various spectra 510, 520, 530, 540 obtained for a “top-hat” kernel are shown in FIG. 5c. FIG. 5 shows the comparison of the modeling, using a Gaussian kernel and a “top-hat” kernel, of a cement sample (type I) with the addition of NaCl analyzed using a LIBS technique. The average spectrum is indicated in the figure as 500.

Various spectra 501, 502, 503, 504 obtained for a Gaussian kernel are indicated on the left in the figure. Various spectra 510, 520, 530, 540 obtained for a “top-hat” kernel are shown on the right in the figure.

For each spectrum, an associated quantile-quantile plot is also shown.

Normally, the data are best reproduced using low bandwidth values, since the quantiles are aligned on the bisector of the plot. Higher values of a show a deviation of the quantiles at low and high intensities. The comparison also shows better adaptation to the data of the “top-hat” kernel for high values of h. On the other hand, at low values of a, a Gaussian kernel adjusts better to the data.

In one variant embodiment, the synthetic distribution of the data may be made even more realistic by adding, during the generation 140 of the synthetic data, an additional random noise source for each wavelength channel. Such a source is modeled as a difference in the number of photons reaching the detector.

The intensity of a spectrum for the wavelength is then given by

$${I}_{n}^{′} = ( 1 + {𝒰}_{m} ) {𝒥}_{n} ,$$

where, for each wavelength channel n, [symbol] ₙ follows a Poisson distribution [symbol] with a parameter Iₙₓ (that is to say [symbol] ₙ˜ [symbol] (Iₙ), where Iₙ is the intensity recorded experimentally for the channel (possibly averaged in step 122) and corresponds to the expected average of the distribution of [symbol] ₙ), m is a noise parameter chosen such that [symbol] ₘ is a number distributed uniformly within the interval [−m, m].

In one variant embodiment, it is possible to define

$${I}_{n}^{′} = {N}_{m} \cdot {𝒥}_{n} ,$$

where m is a noise parameter chosen such that Nₘ is a number distributed according to a normal law centered at 1 and with a standard deviation m, that is to say Nₘ˜ [symbol] (1,m).

In one variant embodiment, the generated synthetic spectral data 150 may be added (step 160) to the measured input data 110 so as to build a set of training data.

As an alternative, it is also possible to use only the synthetic spectra 150 as a learning set since, in general, the number of spectra generated is far greater than the number of experimental data, to the point that the latter become statistically negligible.

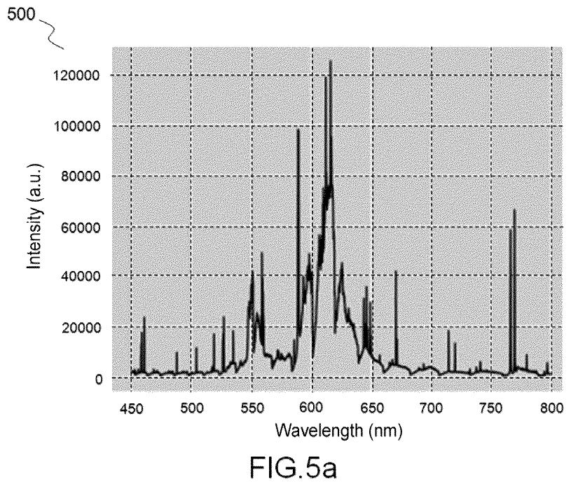

The set of data obtained using the method according to the invention may be used to train a machine learning engine as illustrated in one example in FIG. 3.

The synthetic spectral data are generated in step 301 based on first training spectral data measured in step 300, and are then used as learning data to train an analysis model in step 302. The analysis model may aim for quantitative analysis, for example estimation of the concentration of a chemical species in a sample based on analysis of its spectrum, or qualitative analysis, for example classification of spectra according to the type of sample.

The machine learning model is for example based on one or more convolutional neural networks or any other equivalent machine learning algorithm. The learning data may be used to carry out oversampling and/or regularization of deep learning methods. References [9]-[10]-[12] give, by way of illustration, various learning methods suitable for the qualitative or quantitative analysis of spectral data.

Once the model has been trained, it may be used in step 303 to carry out qualitative or quantitative analysis of new spectral data measured in step 304.

The steps of the invention may be implemented as a computer program comprising instructions for carrying out same. The computer program may be recorded on a processor-readable recording medium.

The reference to a computer program that, when it is executed, carries out any one of the functions described above is not limited to an application program running on a single host computer. On the contrary, the terms computer program and software are used here in a general sense to refer to any type of computer code (for example application software, firmware, microcode, or any other form of computer instruction) that may be used to program one or more processors to implement aspects of the techniques described here. The computing means or resources may notably be distributed (cloud computing), possibly using peer-to-peer technologies. The software code may be executed on any appropriate processor (for example a microprocessor) or processor core or a set of processors, be these provided in a single computing device or distributed among multiple computing devices (for example as may be accessible in the environment of the device). The executable code of each program allowing the programmable device to implement the processes according to the invention may be stored for example in the hard drive or in read-only memory. In general, the one or more programs may be loaded into one of the storage means of the device before being executed. The central processing unit may control and direct the execution of the instructions or portions of software code of the one or more programs according to the invention, which instructions are stored in the hard drive or in the read-only memory or else in the other abovementioned storage elements.

### REFERENCES

[1] M. H. Mozaffari and L.-L. Tay, “A Review of 1D Convolutional Neural Networks toward Unknown Substance Identification in Portable Raman Spectrometer”, ArXiv200610575 Cs Eess, 2020, Accessed: Oct. 29, 2021. [Online]. Available: http://arxiv.org/abs/2006.10575
[2] L. Narlagiri and V. R. Soma, “Simultaneous quantification of Au and Ag composition from Au—Ag bi-metallic LIBS spectra combined with shallow neural network model for multi-output regression”, Appl. Phys. B, vol. 127, no. 9, p. 135, 2021, doi: 10.1007/s00340-021-07681-y.
[3] C. Lu, B. Wang, X. Jiang, J. Zhang, K. Niu, and Y. Yuan, “Detection of K in soil using time-resolved laser-induced breakdown spectroscopy based on convolutional neural networks”, Plasma Sci. Technol., vol. 21, no. 3, p. 34014, 2019, doi: 10.1088/2058-6272/aaef6e.
[4] F. Rosenblatt, The perceptron, a perceiving and recognizing automaton Project Para. Cornell Aeronautical Laboratory, 1957.
[5] Y. LeCun et al., “Backpropagation Applied to Handwritten Zip Code Recognition”, Neural Comput., vol. 1, no. 4, pp. 541-551, 1989, doi: 10.1162/neco. 1989.1.4.541.
[6] Y. LeCun et al., “Handwritten digit recognition with a back-propagation network”, Adv. Neural Inf. Process. Syst., vol. 2, 1989.
[7] D. W. Hahn and N. Omenetto, “Laser-Induced Breakdown Spectroscopy (LIBS), Part II: Review of Instrumental and Methodological Approaches to Material Analysis and Applications to Different Fields”, Appl. Spectrosc., vol. 66, no. 4, pp. 347-419, 2012, doi: 10.1366/11-06574.
[8] L. Jolivet, M. Leprince, S. Moncayo, L. Sorbier, C.-P. Lienemann, and V. Motto-Ros, “Review of the recent advances and applications of LIBS-based imaging”, vol. 151, pp. 41-53, 2019, doi: 10.1016/j.sab.2018.11.008.
[9] C. Shorten and T. M. Khoshgoftaar, “A survey on Image Data Augmentation for Deep Learning”, J. Big Data, vol. 6, no. 1, p. 60, 2019, doi: 10.1186/s40537-019-0197-0.
[10] A. Mikolajczyk and M. Grochowski, “Data augmentation for improving deep learning in image classification problem”, in 2018 International Interdisciplinary PhD Workshop (IIPhDW), Swinoujście, 2018, pp. 117-122. doi: 10.1109/IIPHDW.2018.8388338.
[11] K. Li, D. Dai, E. Konukoglu, and L. Van Gool, “Hyperspectral Image Super-Resolution with Spectral Mixup and Heterogeneous Datasets”, ArXiv210107589 Cs, 2021, Accessed: Jan. 12, 2022. [Online]. Available: http://arxiv.org/abs/2101.07589
[12] Q. Wen et al., “Time Series Data Augmentation for Deep Learning: A Survey”, in Proceedings of the Thirtieth International Joint Conference on Artificial Intelligence, Montreal, Canada, 2021, pp. 4653-4660. doi: 10.24963/ijcai.2021/631.
[13] J. Chen, J. Pisonero, S. Chen, X. Wang, Q. Fan, and Y. Duan, “Convolutional neural network as a novel classification approach for laser-induced breakdown spectroscopy applications in lithological recognition”, Spectrochim. Acta Part B At. Spectrosc., vol. 166, p. 105801, 2020, doi: 10.1016/j.sab.2020.105801.
[14] L. Zou et al., “Online simultaneous determination of H2O and KCl in potash with LIBS coupled to convolutional and back-propagation neural networks”, J. Anal. At. Spectrom., vol. 36, no. 2, pp. 303-313, 2021, doi: 10.1039/DOJA00431F.
[15] T. Chen et al., “Deep learning with laser-induced breakdown spectroscopy (LIBS) for the classification of rocks based on elemental imaging”, Appl. Geochem., vol. 136, p. 105135, 2022, doi: 10.1016/j.apgeochem.2021.105135.
[16] L.-N. Li, X.-F. Liu, F. Yang, W.-M. Xu, J.-Y. Wang, and R. Shu, “A review of artificial neural network based chemometrics applied in laser-induced breakdown spectroscopy analysis”, Spectrochim. Acta Part B At. Spectrosc., vol. 180, p. 106183, June 2021, doi: 10.1016/j.sab.2021.106183.
[17] J. El Haddad et al., “Artificial neural network for on-site quantitative analysis of soils using laser induced breakdown spectroscopy”, Spectrochim. Acta Part B At. Spectrosc., vol. 79-80, pp. 51-57, 2013, doi: 10.1016/j.sab.2012.11.007.
[18] I. Goodfellow, Y. Bengio, and A. Courville, Deep Learning. MIT Press, 2016.
[19] J. J. Bird, D. R. Faria, C. Premebida, A. Ekart, and P. P. S. Ayrosa, “Overcoming Data Scarcity in Speaker Identification: Dataset Augmentation with Synthetic MFCCs via Character-level RNN”, in 2020 IEEE International Conference on Autonomous Robot Systems and Competitions (ICARSC), Ponta Delgada, Portugal, 2020, pp. 146-151. doi: 10.1109/ICARSC49921.2020.9096166.
[20] J. Deng, W. Dong, R. Socher, L.-J. Li, K. Li and L. Fei-Fei, ImageNet: A Large-Scale Hierarchical Image Database. IEEE Computer Vision and Pattern Recognition (CVPR), 2009.

1. A computer-implemented method for synthesizing spectral data, comprising the following steps:
acquiring a set of spectral data each associating a spectrum with a sample having a given chemical composition, using a spectroscopy method, each spectrum having a plurality of intensities as a function of wavelength channels,
determining a theoretical model of the distribution of the intensities of the spectrum for each wavelength channel of the spectrum,
generating a set of synthetic spectral data by generating, for each wavelength channel of the spectrum, a randomly drawn intensity according to the probability distribution of the theoretical model.

2. The method for synthesizing spectral data as claimed in claim 1, wherein the theoretical model is based on a probability distribution in accordance with a Poisson distribution parametrized by the intensity measured on the acquired spectrum.

3. The method for synthesizing spectral data as claimed in claim 1, wherein the set of spectral data comprises multiple measurements of spectra for the same sample and the method comprises a step of determining the average spectrum over the set of measurements.

4. The method for synthesizing spectral data as claimed in claim 1, wherein the synthetic spectral data are generated by adding, to the randomly drawn intensity, a noise value drawn according to a uniform distribution within an interval centered on the intensity and of parametrizable width.

5. The method for synthesizing spectral data as claimed in claim 1, wherein the synthetic spectral data are generated by adding, to the randomly drawn intensity, a noise value drawn according to a normal distribution centered on the intensity, the standard deviation of which is a modifiable parameter.

6. The method for synthesizing spectral data as claimed in claim 1, wherein the spectral data are acquired by way of a laser-induced breakdown spectroscopy method.

7. The method for synthesizing spectral data as claimed in claim 1, wherein the spectral data originate from emission or absorption spectra of chemical species.

8. A method for the quantitative or qualitative analysis of spectral data, comprising the following steps:
generating a set of synthetic spectral data by carrying out the method for synthesizing spectral data as claimed in any one of the preceding claims,
training a machine learning model based on the generated synthetic spectral data,
using the trained model to carry out quantitative or qualitative analysis of spectral data.

9. A computer program comprising instructions for carrying out a method as claimed in claim 1 when the program is executed by a processor.

10. A processor-readable recording medium on which there is recorded a program comprising instructions for carrying out a method as claimed in claim 1 when the program is executed by a processor.
